(19) United States
(12) Patent Application Publication
(10) Pub. No.: US 2012/0021638 A1
(43) Pub. Date: Jan. 26, 2012

(54) MODULAR NETWORK CONNECTOR

(76) Inventor: Edward Douglas Knapton, Spring, TX (US)

(21) Appl. No.: 13/259,631

(22) PCT Filed: May 19, 2009
(86) PCT No.: PCT/US09/44441

§ 371 Date: Sep. 23, 2011

(51) Int. Cl. H01R 13/56

(52) U.S. Cl. 439/445

(57) ABSTRACT

A modular network connector configured to receive a network plug of a cable includes a base and a moveable member. The base includes a plurality of connection pins and network conductors. The moveable member is rotatably coupled to the base. The moveable member is configurable to a first position in which the movable member is parallel to the base and to a second position substantially perpendicular to the base and configured to electrically and mechanically receive the network plug of a cable.

### BACKGROUND

Information technology and the network industry have become highly developed. The demand for network communication is continuing to increase. Almost every personal computer includes a network interface to access a network, (e.g., a local area network or the internet), and even most notebook computers and handheld computers include network interfaces. The market demand has increased towards light, thin, short systems and small characteristics in personal computers and other computer systems. As such, computer internal space has been greatly reduced. These computer systems typically connect to a network via a network cable having a network plug, (e.g. a standard network plug) configured to be inserted into a corresponding network jack (e.g., a standard network jack) of the computer system such as illustrated in FIG. 1. Therefore, the dimensions of the standard network plug of the network cable and standard network jack of the computer system have corresponding values. Although the thickness of a notebook computer or handheld computer has continued to decrease, providing internet or other network connection within the thickness of the device has proven difficult due to the relatively large dimensions of the standard network jack. External dongles or adaptors have been used to remote the actual connector away from a thin notebook.

### BRIEF DESCRIPTION OF THE DRAWINGS

The accompanying drawings are included to provide a further understanding of embodiments and are incorporated in and constitute a part of this specification. The drawings illustrate embodiments and, together with the description, serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a perspective view of a standard network connector.

FIG. 2A is a perspective view of a modular network connector in accordance with one embodiment.

FIG. 2B is a perspective view of a network connector in accordance with one embodiment.

FIG. 3A is a schematic side view of a network plug and a network connector coupled to a printed circuit board according to one embodiment.

FIG. 3B is a schematic side view of a network plug and a network connector coupled to a printed circuit board according to one embodiment.

FIG. 3C is a schematic side view of a network plug and a network connector coupled to a printed circuit board according to one embodiment.

FIG. 4A is an end view of a network connector coupled to a portable electronic device according to one embodiment.

FIG. 4B is an end view of a network connector coupled to a portable electronic device according to one embodiment.

FIG. 5A is an end view of a network connector coupled to a portable electronic device according to one embodiment.

FIG. 5B is an end view of a network connector coupled to a portable electronic device according to one embodiment.

### DETAILED DESCRIPTION

In the following detailed description, reference is made to the accompanying drawings which form a part hereof, and in which is shown by way of illustration specific embodiments in which the invention may be practiced. In this regard, directional terminology, such as “top,” “bottom,” “front,” “back,” “leading,” “railing,” etc., is used with reference to the orientation of the Figure(s). being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that the features of the various exemplary embodiments described herein may be combined with each other, unless specifically noted otherwise.

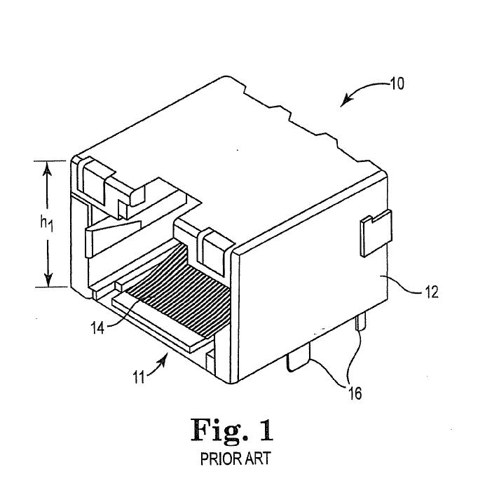

FIG. 1 is a perspective view of a standard network connector 10 including a standard network jack 11. The standard network connector 10 includes a housing 12 having a height h₁ suitable to accommodate connection with a corresponding standard network plug of a network cable. Network connector 10 includes connection pins/conductors 14 which are configured to provide electrical connection and communication with the network plug when the network plug is inserted. Network connector 10 includes circuit board connectors 16 for coupling the network connector 10 to a printed circuit board of an electronic device such as a computer system device.

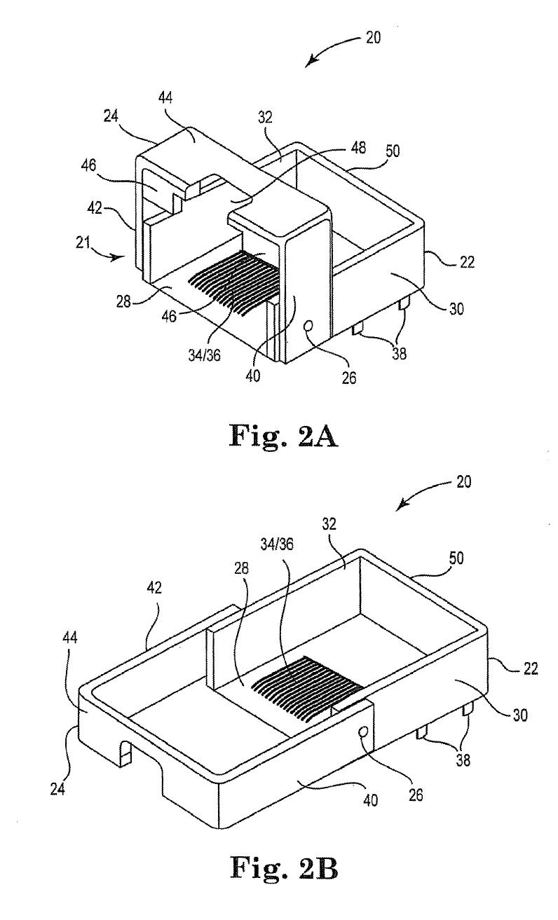

FIG. 2A is a perspective view of a modular network connector 20 having a network jack 21 according to one embodiment. Modular network connector 20 includes base 22 and moveable member 24. Base 22 and moveable member 24 rotatably couple at pivot point 26.

Base 22 of network connector 20 includes bottom face 28 and at least two opposing sides 30 and 32. Bottom face 28 has a plurality of connection pins 34 and network conductors 36. Connection pins 34 and network conductors 36 are comprised of any suitable materials for transmitting power and signals. Bottom face 28 is configured such that the plurality of connection pins 34 and network conductors 36 electrically couple with a network plug of a cable. In one embodiment, bottom face 28 also includes circuit board connectors 38 extending in a direction generally opposite connection pins 34 and network conductors 36. Circuit board connectors 38 are configured to mechanically couple to a printed circuit board (not shown).

In one embodiment, end cap 50 of base 22 extends between opposing sides 30 and 32. In one embodiment, end cap 50 provides stability and prevents damage to connection pins 34 of bottom face 28 from the lateral direction. In one embodiment, base 22 of network connector 20 is manufactured from plastic or other suitable material. Network connector 20 can be mechanically and electrically coupled to any portable electronic equipment, such as a thin notebook computer or other electronic device employing an electrical connection and where there is a desired thinness of the device. In one embodiment, the portable electronic device employs network interface connection pins 34 to form a contact area on the modular network connector 20 for electrically connecting a plug 54.

Moveable member 24 includes first side 40, opposing second side 42, and third side 44 between first side 40 and opposing second side 42. In one embodiment, moveable member 24 includes extensions 46 and recess 48. Extensions 46 are located, one each, respectively at the intersection of third side 44 with first side 40 and second side 42. Recess 48 is located on third side 44 of moveable member 24 and is positioned between extensions 46. Recess 48 and extensions 46 are configured for mechanical attachment with a locking tab or a network plug.

Pivot point 26 is a connection point between base 22 and moveable member 24 of network connector 20. Pivot point 26 is a point of rotation between base 22 and moveable member 24. Pivot point 26 may be formed by pins or another adjustable connection mechanism. In one embodiment, pivot point 26 is formed with a spring loaded hinge. In one embodiment, pivot point 26 provides a releasable locking mechanism when moveable member 24 is in a first or second position.

In one embodiment, network connector 20 is RJ45 network connector (or other suitable standard network connector) compatible with an RJ45 plug or other suitable network plug of a network cable. In one embodiment, the network connector and plug are a data network connector and plug of a network cable. In another embodiment, the network connector and plug are a phone network connector and plug. Both the connector construction and wiring pattern is appropriate for a standardized physical network interface, such as for telecommunication or data equipment. The term RJ45 connector is a type of registered jack (RJ) modular connector and herein given its broadest meaning which includes many types of modular connectors, including conventional 8P8C modular connectors and other RJ connectors.

FIG. 2B illustrates a perspective view of network connector 20 according to one embodiment. Network connector 20 in this embodiment includes base 22 substantially parallel with moveable member 24. In one embodiment, network connector 20 in a collapsed position decreases the overall height of network connector 20.

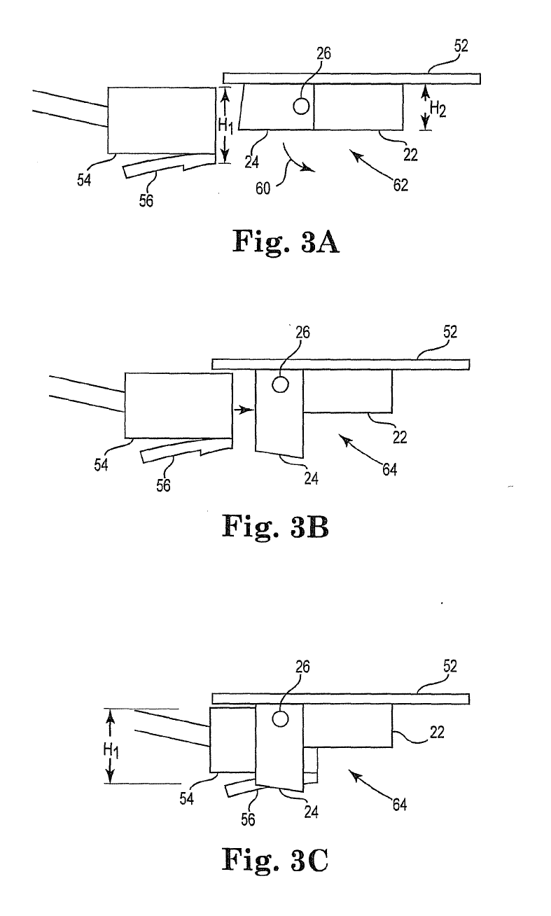

FIGS. 3A-3C illustrate schematic side views of network plug 54 and corresponding network connector 62/64 coupled to printed circuit board 52 according to one embodiment. As illustrated in FIG. 3A, a first position is achieved when moveable member 24 is substantially parallel to, and aligned with, base 22 and PCB 52. As illustrated in FIG. 3A, a network plug 54 has a height H₁ and network connector 62 has a first position height of H₂. In this position, both base 22 and moveable member 24 of network connector 62 have a height of H₂ which is less than H₁ and height h₁ of standard network connector 10 of FIG. 1. In this first position, network connector 62 and network plug 54 cannot be coupled.

FIG. 3B is a schematic side view of network plug 54 and corresponding network connector 64, according to one embodiment. A second position is obtained when moveable member 24 is positioned generally perpendicular to base 22 and PCB 52. In one embodiment, moveable member 24 is manually moved from the first position, illustrated in FIG. 3A, to the second position, illustrated in FIG. 3B. Moveable member 24 is relocated with respect to base 22 in direction of rotation 60. In the second position, network connector 64 has a height of H₁ corresponding to and suitable for connection with network plug 54. As such, moveable member 24 is rotated into the second position to provide network connector 64 with a H₁ height compatible with network plug 54.

In the embodiment illustrated in FIG. 3C, network plug 54 is inserted into network connector 64. When inserted into network connector 64, tab 56 of network plug 54 corresponds and aligns with recess 48 (illustrated in FIG. 2A). In one embodiment, tab 56 is a locking tab which provides a mechanism of releasably securing network plug 54 into network connector 64.

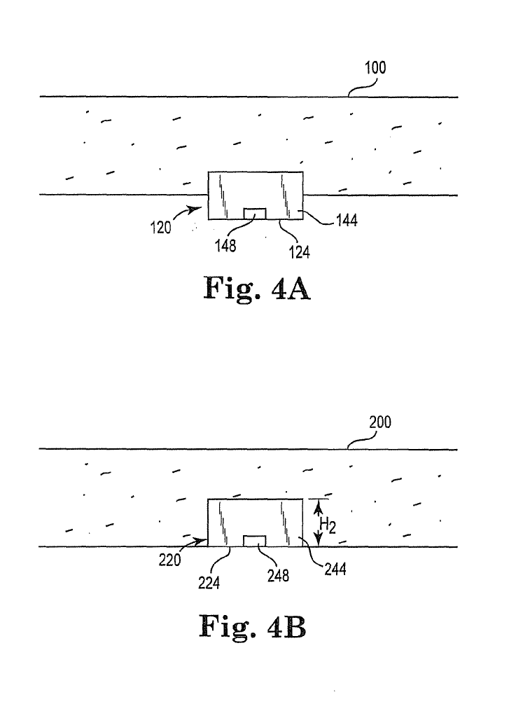

FIG. 4A illustrates an end view of a network connector 120 coupled to a portable electronic device 100. In one embodiment, portable electronic device 100 is a thin notebook computer, although a portable electronic device can be embodied in any other suitable portable electronic devices which employs network connectivity. In one embodiment, network connector 120 is partially recessed into portable electronic device 100. In the view illustrated in FIG. 4A, third side 144 and recess 148 of movable member 124 are visible. When a network communication is not desired, the network connector 120 and moveable member 124 are positioned parallel to base 122 (not visible in FIG. 4A). In a collapsed state, the thickness of the network connector 120 is minimized, and the corresponding thickness of the portable electronic device 100 can correspondingly also be minimized.

FIG. 4B illustrates an end view of a network connector 220 coupled to a portable electronic device 200 (e.g., a notebook computer). In one embodiment, network connector 220 is recessed within portable electronic device 200 the full height H₂ of moveable member 224 of network connector 220. Network connector 220 is illustrated here in the collapsed state.

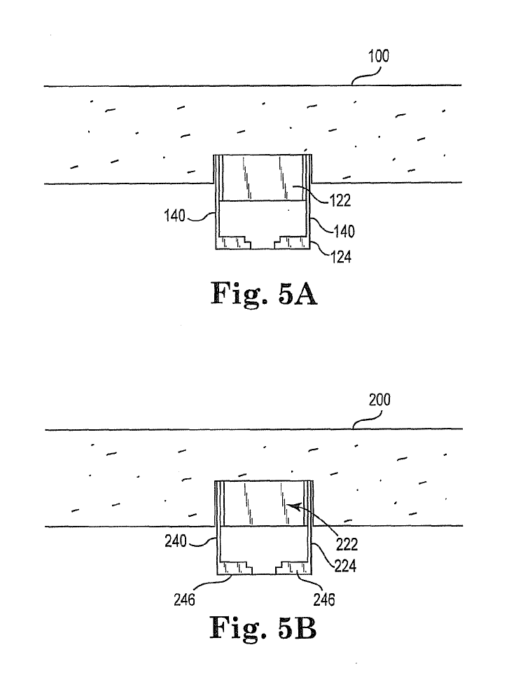

FIGS. 5A and 5B illustrate end views of network connectors 120/220 coupled to portable electronic devices (e.g., notebook computers) 100/200 of FIGS. 4A and 4B. In these embodiments, moveable members 140/240 have been rotated and the network connectors 120/220 are configured for connection to a network plug.

Although specific embodiments have been illustrated and described herein, it will be appreciated by those of ordinary skill In the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A modular network connector configured to receive a network plug of a cable, comprising:
a base having a plurality of connection pins and network conductors; and
a moveable member rotatably coupled to the base which is configurable to a first position in which the movable member is parallel to the base and to a second position substantially perpendicular to the base and configured to electrically and mechanically receive the network plug of a cable.

2. The modular network connector of claim 1, wherein the movable member comprises a first side, an opposing second side and a third side between the first side and the second side.

3. The modular network connector of claim 1, wherein the height of the connector in the first position is less than a height of the connector in the second position.

4. The modular network connector of claim 1, wherein the moveable member is connected to base with a spring loaded hinge.

5. The modular network connector of claim 1, wherein the base is attachable to a printed circuit board of a portable electronic device.

6. The modular network connector of claim 5, wherein the portable electronic device is a notebook computer.

7. The modular network connector of claim 1, wherein the modular network connector is configured to receive a data network plug.

8. The modular network connector of claim 1, wherein the network connector is configured to receive a phone network plug.

9. A modular network connector comprising:
a collapsible portion further comprising:
a rotatable member having a first side, an opposing second side and third side between the first side and opposing second side;
a base having a bottom face, and at least two opposing sides;
wherein the opposing second and third sides of the rotatable member are coupled to the at least two opposing side of the base; and
a plurality of connection pins configured to releasably electrically couple to a network plug, wherein the plurality of connection pins additionally electrically couple to a printed circuit board, wherein the plurality of connection pins are positioned on the bottom face of the base.

10. The connector of claim 9, wherein the first face of the rotatable member in a collapsed position is adjacent to the printed circuit board.

11. The connector of claim 9, wherein the first face of the rotatable member in a rotated position is perpendicular to the printed circuit board.

12. The connector of claim 9, wherein the first face further comprises extensions at the intersection of the first side and the second side and the intersection of the second side and the third side.

13. The connector of claim 9, wherein the first side of the rotatable member comprises a recess.

14. The connector of claim 9, wherein a direction of rotation of the rotatable member is toward the base.

15. A portable electronic device capable of network communications, comprising:
a printed circuit board;
a collapsible network connector further comprising;
a base coupled to the printed circuit board, the base including a plurality of connection pins and network conductors; and
a moveable member rotatably coupled to the base which is configurable to a first position in which the movable member is parallel to the printed circuit board and to a second position substantially perpendicular to the printed circuit board and configured to electrically and mechanically receive a network plug of a cable.

16. The portable electronic device of claim 15, wherein the portable electronic device is a notebook computer.
